(19) United States
(12) Patent Application Publication
(10) Pub. No.: US 2012/0169063 A1
(43) Pub. Date: Jul. 5, 2012

(54) PERMANENT MAGNET GENERATOR

(75) Inventors: Johannes Abraham Stegmann, Langerug (ZA); Maarten Jan Kamper, Stellenbosch (ZA)

(73) Assignee: Stellenbosch University, West Cape Province (ZA)

(21) Appl. No.: 13/496,073

(22) PCT Filed: Sep. 17, 2010
(86) PCT No.: PCT/IB10/02329

§ 371 Date: Mar. 14, 2012

(30) Foreign Application Priority Data
Sep. 18, 2009 (ZA) 2009/06507

(51) Int. Cl. H02K 5/02; F03D 9/00; H02K 15/02; H02K 1/12

(52) U.S. Cl. 290/55; 310/254.1; 310/43; 29/598

(57) ABSTRACT

A new configuration for a double-sided rotor, radial flux, air-cored, permanent magnet electric generator (1) is disclosed. The generator (1) includes two radially spaced apart rotor portions (33, 35) defining an air gap between them and each having a plurality of alternating polarity permanent magnets (41) arranged on their inner surfaces, mounted for rotation in the air gap. A modular stator (43) is positioned in the air gap and includes a base (45) having attachment formations (60) spaced apart about its surface and a plurality of individually moulded, polymeric resin stator modules (53). Each stator module (53) has complementary attachment formations (59) for attachment to the base (45) and includes at least one non-overlapping compact wound coil (61) which is embedded within the resin.

### FIELD OF THE INVENTION

This invention relates to an electrical generator. More particularly, the invention relates to a design for a permanent magnet electrical generator for use with a wind turbine. The invention extends to a method for manufacturing a permanent magnet electrical generator.

### BACKGROUND TO THE INVENTION

Electrical generators are devices that convert mechanical energy into electrical energy and are well known. The underlying operating principal of these generators can be found in Faraday's law which, in its most basic form, states that an electrical potential difference is generated between the ends of an electrical conductor that moves perpendicularly through a magnetic field. More specifically, that the electromotive force (EMF) that is induced in any closed circuit is equal to the time rate of change of the magnetic flux through the circuit.

An electrical generator in its most simple form comprises a rotor and a stator. The rotor is a rotating part of the generator and the stator is a stationary part. One particular class of electrical generator makes use of permanent magnets (PMs), mounted on either the rotor or the stator, to establish a magnetic field (flux) in the generator. These generators are referred to as permanent magnet generators. Coils of conductive material (normally copper wire) are secured to either the stator or the rotor of the generator and as the rotor rotates with respect to the stator, the movement of the magnetic field relative to the conductive windings induces a current in the windings. The current so induced may then be used to power electrical appliances or to store electrical charge by, for example, charging batteries.

Electrical generators are currently used in a number of applications, but are becoming increasingly popular for use in wind generators, mainly because electricity generated by means of wind is considered to be a clean source of energy. Wind generators convert the kinetic energy of wind into mechanical (mostly rotational) energy which is then converted into useful electrical energy. A basic wind generator includes a number of aerofoil shaped blades, mounted on an axle for rotation in wind. The rotation is imparted to the rotor of an electrical generator which, in turn, generates electricity.

Conventional wind generators suffer from a number of disadvantages. One such disadvantage is that the majority of such generators utilize iron core stators. Apart from the high cost associated with iron cores, they are also heavy and require additional resources and support to install, stabilize and maintain. Iron core stators also suffer from cogging torque, which is the torque resulting from the interaction between the permanent magnets of the rotor and the stator slots of a PM machine. It is also known as detent or “no-current” torque. Cogging torque is an undesirable component for the operation of iron-core electric generators. It is especially prominent at lower speeds and manifests itself in stuttered rotation.

A further disadvantage of conventional wind generators is the cost associated with their repair and maintenance. In particular, where windings on either the rotor or stator become worn or defective, highly skilled technicians are-required to conduct repair or maintenance. The weight and unwieldiness of conventional iron-core stators also often require the use of machinery or teams of technicians to conduct even routine maintenance.

One improved type of wind generator that has been used with some success, particularly in wind generators, is known as a double-sided rotor, air-cored permanent magnet generator. Due to its air core stator, the generator does not suffer from some of the disadvantages mentioned above resulting from a heavy iron core generator. These generators have numerous advantages such as no core losses, zero cogging torque, no attractive forces between the stator and rotor and the ability of replacing faulty stators in situ. The stators are, however, still difficult to repair and maintain, and still require highly skilled technicians and expensive equipment to do so. In addition, these machines suffer from large attractive forces between the two PM rotors and normally require a relatively large number of PM magnets to operate due to the fact that they have a relatively larger air gap between the rotors and stator.

### OBJECT OF THE INVENTION

It is an object of this invention to provide a permanent magnet generator which will at least partially alleviate some of the abovementioned problems.

### SUMMARY OF THE INVENTION

In accordance with this invention there is provided an air-core stator for a permanent magnet electric generator comprising a base having attachment formations spaced apart about its surface and a plurality of stator modules each having complementary attachment formations, wherein the stator modules include at least one non-overlapping conductive winding each and are releasably secured to the base by means of the attachment formations in a side-by-side configuration so as to form a substantially circular stator body.

Further features of the invention provide for the base to be disc shaped and to define apertures about its periphery, the apertures serving as the attachment formations; and for each stator module to be integrally moulded from a polymer resin, preferably an epoxy resin, and to have a part circular outer surface, an arcuate body and a flange projecting substantially normally from an edge thereof in a direction of concave curvature of the body, the complimentary attachment formations being apertures defined in the flange and spaced apart so as to register with the attachment formations on the base, enabling the module to be bolted to the base.

Still further features of the invention provide for the outer surfaces of the modules to form a substantially continuous circular stator surface when all the modules are secured to the base; for the bodies of the stator modules to form a substantially continuous annular stator body projecting substantially normally from the base when secured thereto; for each stator module to include a plurality of generally oblong conductive coils arranged in side by side configuration on the arcuate body with their longitudinal axes substantially parallel to each other and extending across a width of the annular stator body; and for the coils to be non-overlapping and compact wound and imbedded in the polymer resin during moulding of the stator modules with a connecting region of the coils extending outside the module for electrical connection outside the module body.

The invention also provides a wind turbine for generating electrical power including a turbine rotor mounted for rotation to be driven by wind and a generator coupled to the turbine rotor such that the turbine rotor drives the generator, the generator comprising an air core stator located in a magnetic air gap between two generally annular rotor portions mounted to rotate together on opposite sides of the air core stator, the rotor portions including arrays of alternating polarity permanent magnets such that the permanent magnets drive magnetic flux back and forth between the rotor portions and through the air core stator when the turbine rotor rotates; the wind turbine being characterized in that the air core stator is made up of a plurality of stator modules, each supporting one or more compact wound conductive coils in the magnetic air gap.

Further features of the invention provide for the air core stator to comprises a base which is securable to a stationary support structure of the wind turbine and to which the plurality of stator modules are secured in side by side configuration, each stator module having a generally arcuate body so that the bodies of the stator modules form a substantially continuous annular stator body projecting substantially normally from the base and into the magnetic air gap when secured to the base; for each stator module to be integrally moulded from a polymer resin, preferably an epoxy resin, and for the one or more compact wound conductive coils to be embedded within the resin and configured to be electrically connected outside the stator module bodies; and for each coil to have multiple phase windings consisting of multiple individually insulated conductive wires that are wound in a concentrated manner so as to have two separate portions, namely an active length portion and an end turn portion, the end turn portion, in use, being located outside the magnetic air gap so as to traverse predominantly circumferentially and the active portion being located within the magnetic air-gap so as to traverse predominantly non-circumferentially and perpendicularly to the direction of the magnetic air-gap.

The invention still further provides a stator module for a modular stator of a permanent magnet generator comprising an integrally moulded, polymeric resin body having a generally arcuate shape and a flange projecting substantially perpendicularly from an edge thereof in a direction of concave curvature of the body, at least one aperture defined in the flange, and at least one conductive winding.

Further features of the invention provide for the conductive winding to be a compact wound coil having multiple conductive windings wound into a generally oblong shape, the coil being embedded in the module body; and for the stator module to include multiple coils embedded in the body such that they are arranged side by side with their major axes parallel to each other and across a width of the module body.

The invention still further provides a method of manufacturing a double-sided rotor, radial flux, air-cored, permanent magnet electric generator comprising the steps of attaching arrays of multiple alternating polarity permanent magnets to ferromagnetic back iron yokes and securing the arrays to the inside surfaces of two radially spaced apart rotor portions of the generator such that the permanent magnets drive magnetic flux back and forth through an air gap between the rotor portions; securing a stator base having a plurality of attachment formations to a stationary support structure of the generator; inserting a plurality of individually moulded, non-magnetic stator modules, each having an arcuate module body, complementary attachment formations and at least one conductive winding embedded in the module body, transversely into the air gap; and securing each stator module to the stator base by means of the attachment formations on the base and the complementary attachment formations of the modules, such that the module bodies of the stator modules form an annular stator body positioned in the air gap when all the stator modules are connected to the stator base in a side by side configuration.

Further features of the invention provide for the method to include the steps of embedding at least one compact wound coil into each module body and for embedding multiple coils into each stator module body such that they are arranged side by side with major axes parallel to each other and across a width of the annular stator body.

### BRIEF DESCRIPTION OF THE DRAWINGS

The invention will now be described, by way of example only with reference to the accompanying representations in which:

FIG. 1 is a diagrammatic part-sectional perspective view of an electric generator in accordance with the invention;

FIG. 2 is a second part-sectional perspective view of the electric generator shown in FIG. 1;

FIG. 3 is diagrammatic perspective view of a modular stator for an electric generator in accordance with the invention;

FIG. 4 is a cross section of a double rotor air-cored RFPM generator;

FIG. 5 is a graph indicating examples of wind speed distribution on different sites;

FIG. 6 is an equivalent circuit of the wind generator system referred to in the description;

FIG. 7 is a graph indicating turbine blade power curves;

FIG. 8 is a graph indicating magnet cost and height versus magnet grade for a given air gap flux density;

FIG. 9 is a table showing typical generator characteristics;

FIG. 10 indicates yoke deformation with a yoke wall thickness of 4 mm;

FIG. 11 is an electromagnetic FE field plot of the PM generator;

FIG. 12 is a pie chart indicating approximate cost of the parts of the generator;

FIG. 13 is a pie chart indicating mass distribution of the parts of the generator;

FIG. 14 is graph indicating open circuit phase voltages representing test data for the generator;

FIG. 15 is a simplified load test phasor diagram with δ=51°; and

FIG. 16 is a graph indicating the FE calculated instantaneous developed torque of the generator when used in a three phase balanced resistive loading system.

### DETAILED DESCRIPTION WITH REFERENCE TO THE DRAWINGS

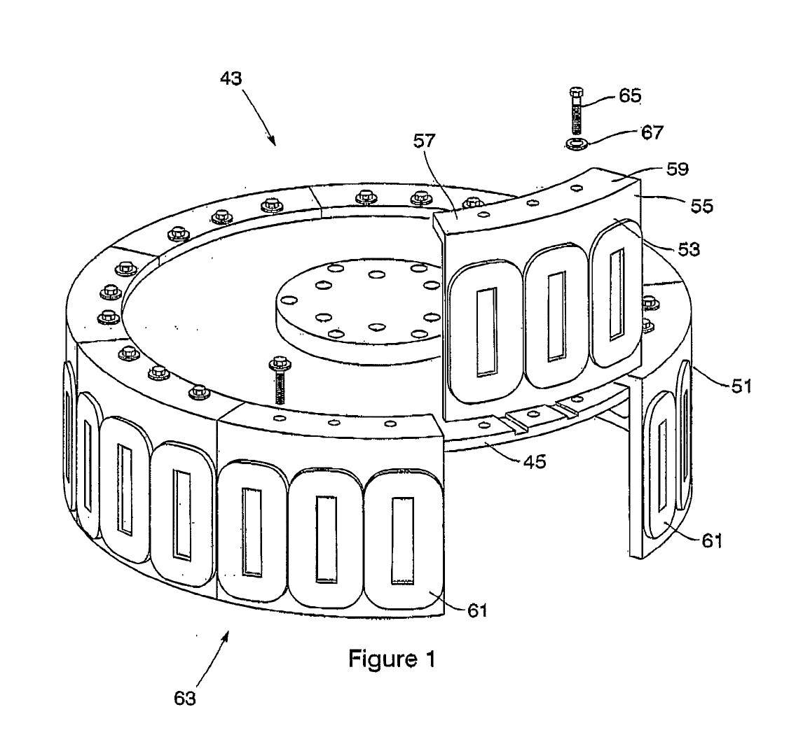

In the embodiment of the invention illustrated in FIGS. 1 and 2, an electric generator is generally indicated by numeral (1) and comprises a main support structure (3) in the form of a shaft, which acts as the support for the entire generator. The shaft, which in this design is non-rotating, is fastened to a wind turbine tower or nacelle (not shown) by means of non-permanent bolted connections through bolt holes (5) in the shaft base (7). Two similar deep groove roller ball bearings (9) are positioned on the shaft. The bearings connect the stationary shaft (3) to the rotating rotor (11). To keep the bearings in position and spaced apart, an aluminium spacer (13) is slid onto the shaft between the bearings. A circular clip, or snap ring (15), prevents the front bearing (17) from sliding off the end of the shaft and a step (19) in the shaft base (7) holds the rear bearing (21) in place.

A rotor bearing hub (23) and front plate (29) are used to engage two rotor portions with the bearings. The rotor hub has a snug fit around both bearings and is fastened in place with a number of grub screws (not shown). The circular front plate (29) is connected to a flange (31) projecting from the hub (23) by means of additional screws (32). The rotor portions, which are a pair of cylindrical ferromagnetic steel rotors, respectively forming an inner (33) and outer (35) rotor, are mounted spaced apart on the circumference of the front plate by means of additional screws (37). The rotors (33 and 35) are concentric and define a uniform air gap (39) between them.

The front plate, which is manufactured from aluminium, is also used to mount three aero-foil type lift blades (not shown). The blades are spaced equal distances (120 degrees) apart to ensure a balanced assembly.

The rotors (33 and 35) serve partly as yokes for arrays of multiple alternating polarity permanent magnets (41). In the current embodiment there are 32 permanent magnets on both the inner and outer rotors. The magnets on the outer rotor (35) are positioned to face inwards and the magnets on the inner rotor (33) outwards, both towards the air gap. When rotating, the permanent magnets drive magnetic flux back and forth between the rotor portions in the air gap.

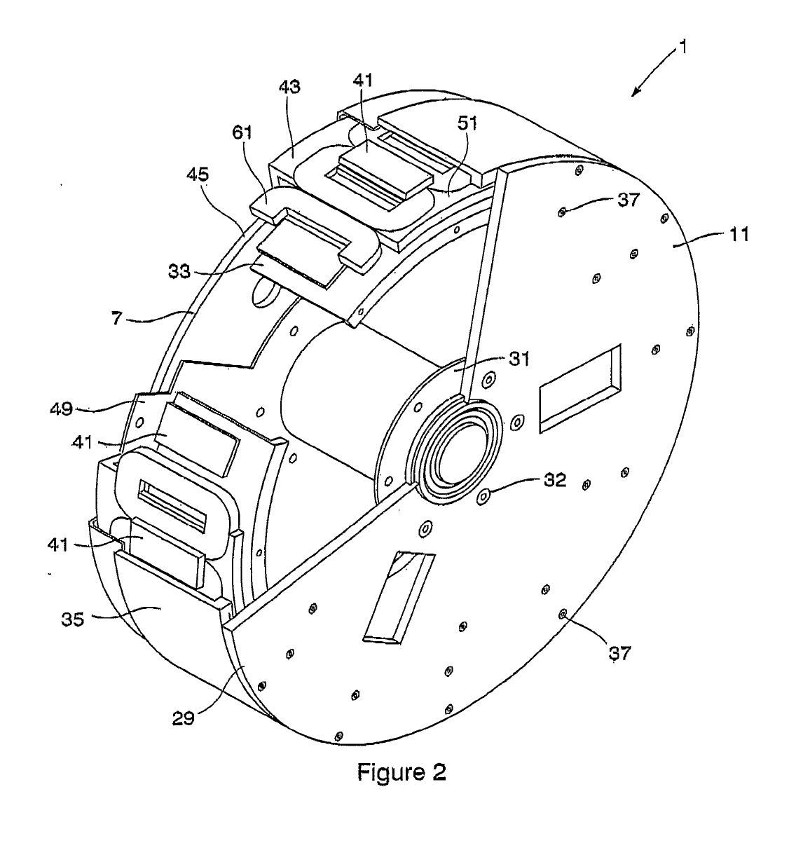

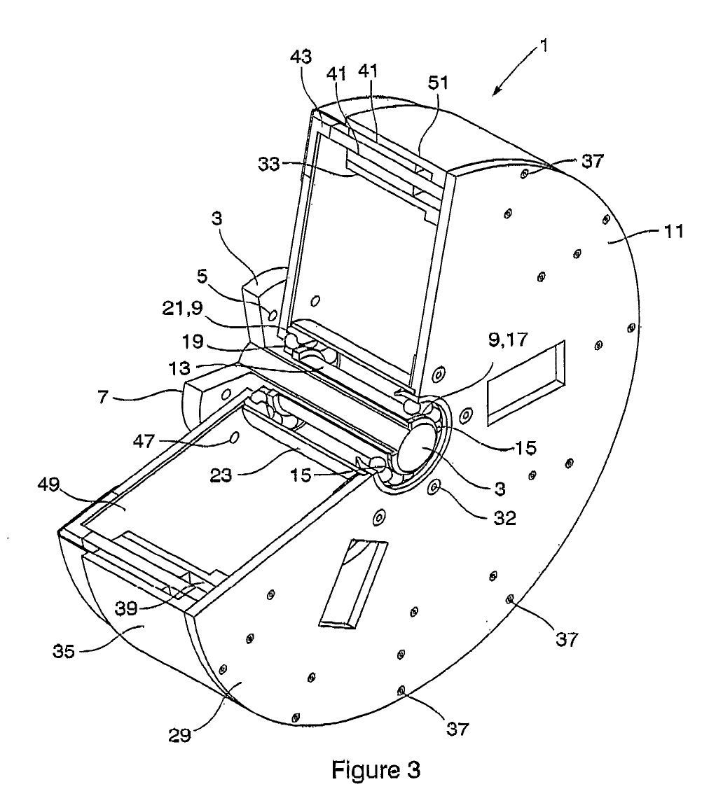

The stator (43) has a circular base plate (45), which is manufactured from aluminium. The base plate (45) is mounted on the base (7) of the main shaft (3) by means of a number of bolts (47). A washer plate (49) may also be attached inside the stator (43) on top of the base (45), to assist with the manufacture and mounting thereof, however, applicant foresees that such a washer plate may be omitted in preferred assemblies. The stator further has an annular stator body (51) having a cylindrical stator outer surface (52), shown in more detail in FIG. 3, which is made up of eight equally sized, polymer resin, in the current example an epoxy resin, moulded stator modules (53). Each module is moulded separately and has an arcuate module body (55) with a part-circular outer surface (56) and a flange (57) projecting perpendicularly therefrom in the direction of concave curvature of the module body. The flange (57) defines three bolt holes (59) that serve as attachment formations by which the modules (53) may be bolted to the base plate (45) through complementary attachment formation (60) in the form of bolt holes defined on its periphery. It will be appreciated that once all the stator modules have been secured to the base plate side-by-side, the individual module bodies (55) form the continuous, annular stator body (51).

Each stator module (53) further has three copper coils (61) moulded within the arcuate module body (55). The coils are kept together by the strong bonding epoxy resin. The coils are substantially oblong and are arranged side by side on the arcuate body with their major axes parallel to each other and across the width of the annular stator body (51). The coils are non-overlapping and are compact wound. It will be appreciated that the coils are embedded in the epoxy resin during moulding of the stator modules and that they may be electrically connected outside the epoxy resin.

To make this possible, the multiple phase windings consist of multiple individually insulated conductor wires that is wound (in a concentrated manner) to have two separate portions, namely an active length portion and an end turn portion. The end turn portions are typically located outside the magnetic air-gap and traverses predominately circumferentially. The active length portions, in contrast, are typically located in the magnetic air-gap and traverse predominately non-circumferentially and perpendicular to the direction of the magnetic air-gap.

Each of the eight stator modules are produced separately in a mould and then secured to the aluminium stator base plate in the final stator assembly (63) with fastener bolts (65) and spacers (67). The coil connections are made after casting the epoxy resin modules and are electrically connected outside the epoxy, which in turn serves as an efficient isolator. The stator assembly is therefore modular and can be manufactured so that the modules are interchangeable between any other stator of the same design. This ensures that the maintenance and repair of these stators is a simple endeavour which does not require highly skilled technicians.

It will be appreciated that once the support shaft, rotor portions, front plate and stator base plate have been secured in place, the stator modules may be introduced transversely into the air gap between the rotors, and secured side-by-side to the base plate. They may then be electrically connected for operation. During operation the rotation of the rotor blades will cause the front plate and both rotor portions to rotate together. The rotating rotor portions and associated flux rotation through the air gap driven by the permanent magnets will induce current in the coils of the stationary modular stator.

Numerous modifications may be made to the embodiment described above without departing from the scope of the invention. In particular, the stator may have of any number of modules and each module may have between one and however many number of wound coils. In other words, the modules may contain multiple coils or as little as a single copper winding. It is, for example, also envisaged that the stator modules may be sold separately and modules with defective coils or windings may therefore be replaced cheaply and easily. If a particular module is found to be defective it may simply be detached from the stator base plate, removed transversely from between the rotor portions and replaced with a functional module.

The generator in accordance with the invention has been found to be particularly effective in reducing the overall weight of the unit and has particular application in direct drive wind generators operating at low to medium power levels.

With the invention as described above in mind the applicant has, through analytical modelling and design found that a double rotor radial flux permanent magnet wind generator with non-overlap air-cored stator windings in accordance with the invention may be optimized by using certain specified parameters. The details of the modelling and design and the conclusions drawn therefrom are set out below. It will be appreciated that the details of the modelling and design as well as the conclusion thereof in no way limit the scope of the invention.

In the remainder of this description the following symbols will have the indicated meanings:

B_{g} Average air-gap flux density (T).

Bᵣ Residual magnetic flux density (T).

Bₚ Peak flux density in the air gap (T).

C₁ Machine constant 1 (See Appendix).

C₂ Machine constant 2 (See Appendix).

δ Phase angle between current and induced EMF (deg).

dₛ Average stator diameter (m).

d Diameter of the copper wire (m).

dᵢ Average diameter of the inner curved magnets (m).

dₒ Average diameter of the outer curved magnets (m).

δ_{c} Ratio between the end-winding length and active length.

g Stator air-gap length (m).

hₘ Magnet height (thickness) (m).

H_{c} Coercive magnetic field strength (A/m).

I_{RMS} RMS value of rated generator current (A).

J Current density in windings (A/mm²).

k_{f} Copper filling factor.

k_{w} Winding factor.

kₑ End-winding factor for non-overlapping winding.

k Per unit coil-side width.

l Axial active length of windings (m).

l_{ipg} Inter polar gap (m).

l_{g} Air-gap length (m).

M_{cu} Copper mass (kg).

Mₘ Magnet mass (kg).

N Number of coil turns.

ηMachine efficiency (%).

σₘ Magnet material density (kg/m³).

σ_{cu} Density of copper (kg/m³).

ρ_{cu} Resistivity of copper (Ωm).

P_{cu} Stator copper losses (W)

P_{Eddy} Machine eddy-current losses in the stator coils (W).

P Rated output power of the generator (W).

p Number of PM magnet poles

Q Number of stator coils.

r Average stator radius (m).

Rₛ System resistance (Ω).

wₑ Electrical frequency=2nf (rad/s).

Tₘ Per unit magnet pitch.

μ₀ Permeability of air (4n×10⁻⁷ H m⁻¹).

S_{f} Mechanical safety factor.

σ_{Y} Yield stress of the material used (Pa).

The use of double rotor air-cored winding permanent magnet (PM) machines have numerous advantages including reduced or no core losses, cogging torque, attraction forces between stator and rotor and the possibility of in-situ replacement of faulty stators. The use of non-overlapping concentrated stator windings has been shown to be very advantageous in terms of ease of manufacturing and assembling, the saving of copper and the performance of the machine. However, the drawbacks of these machines namely the large attraction forces between the PM rotors and the relatively large amount of PM material used due to the large air gap, seem to be overwhelming; the latter is possibly the reason for the relatively little work that has been published on these machines and the low number of applications in larger power levels.

No work as far as the applicants are aware has been published on the optimal design and critical evaluation of the RFPM air-cored machine and to what extent these machines have the same drawbacks as in the axial flux PM (AFPM) counterparts. Consideration is therefore given here to the electromagnetic and mechanical design of the double rotor RFPM air-cored generator through analytical and finite element analysis. The aim in the optimal design is to minimise the active mass of the generator subject to power and efficiency constraints. Mass and cost explanations are thus of interest.

The focus of the study is on direct drive wind generator applications in the low to medium power level.

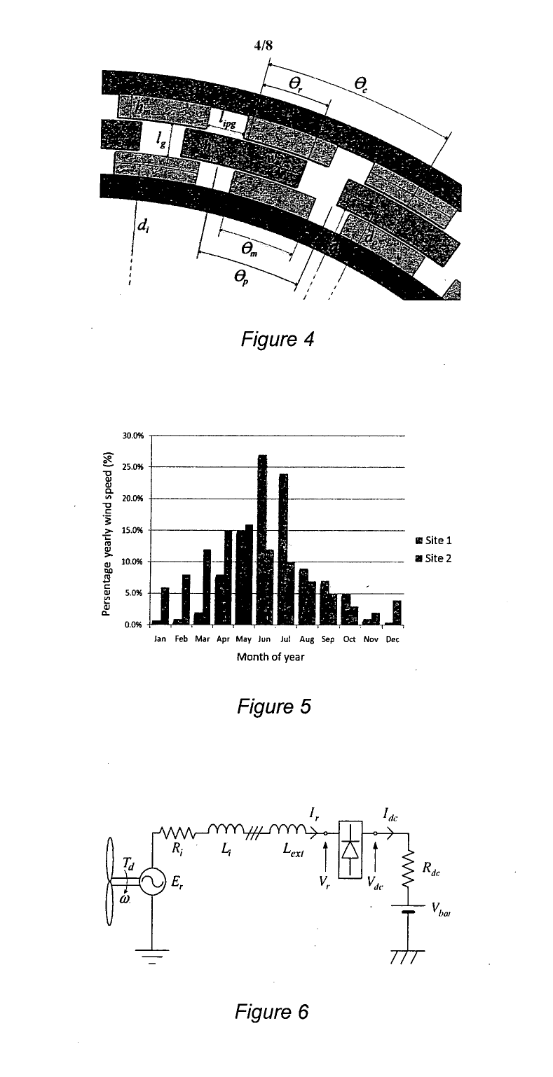

A cross-section of the double rotor RFPM machine with some dimensional parameters is shown in FIG. 4. For this machine a non-overlap (non-overhang) stator winding is compulsory otherwise the assembling will not be possible or will be very difficult. Little space for the end windings inside the machine makes this an even more important winding topology. The electromagnetic design of the machine is governed largely by the developed torque and efficiency constraints. The developed torque can be expressed as

T_{d}=k_{w}kₑC₁cosδ (1)

where k_{w} and kₑ are winding and end-winding factors; C₁ is a machine constant. The angle depends on the load system, e.g. a battery charging system with a series connected inductor. The machine efficiency can be expressed as

$$η = ( 1 - \frac{{P}_{cu} + {P}_{Eddy}}{P} ) \times 100 \% . \qquad ( 2 )$$

The eddy-current losses can be calculated as

$${P}_{Eddy} = 1.7 NQ ( \frac{π {ld}^{4} {B}_{p} {ω}_{e}^{2}}{32 {ρ}_{cu}} ) , \qquad ( 3 )$$

where the factor 1.7 accounts for the eddy-current losses due to all the flux density harmonics. The copper losses are calculated as

P_{Cu}=31_{RMS}²Rₛ (4)

The design parameters to be minimised are the mass of the magnets and copper, represented respectively by (5) and (6))as

Mₘ=τₘπσₘhₘl(dᵢ+dₒ) (5)

M_{cu}=πκC₂(2+δ_{c}) (6)

with C₂ and δ_{c} defined in the appendix. The per unit coil width K and the per unit magnet pitch τₘ are given by

$$κ = \frac{{θ}_{r}}{{θ}_{c}} ; {τ}_{m} = \frac{{θ}_{m}}{{θ}_{p}} \qquad ( 7 )$$

Another factor governing both the mass and electromagnetic aspects of the generator is the magnet height given by

$${h}_{m} = ( \frac{( 0.5 {l}_{g} {B}_{g} )}{1 - \frac{{B}_{g}}{{B}_{r}}} ) {μ}_{0} \vert {H}_{c} \vert with {l}_{g} = h + 2 g \qquad ( 8 )$$

Equations (1)-(6) are independent of the number of poles, except the end-winding factor which varies little with number of poles.

For wind generator applications it is very important to minimize the mass and thereby also the cost of the generator, obviously subject to certain constraints.

When optimising the design of a wind turbine, site-specific characteristics can be included in the design process. For example, to reduce the turbine's energy production costs, the turbine can be optimally designed for different sites that have different wind conditions (as shown in FIG. 5). These designs are advantageous in scenarios where a large number of units are installed in one location, e.g. offshore wind farms. Carrying out site-specific wind turbine optimisation, however, has its disadvantages. The industry trend is rather to produce a standard range of turbines, each operating at different conditions, than to redesign the generator for each new site.

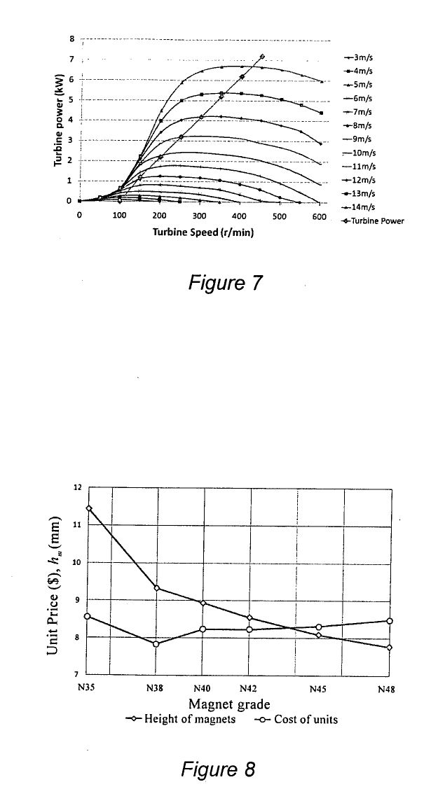

In this description the focus is on a direct battery charging system as shown in FIG. 6. The power versus speed curves of the turbine blades considered in the paper are shown in FIG. 7. The generator system uses passive components to lower its cost. With passive components, however, peak power tracking cannot be realised at every wind speed. To follow the peak power at each wind speed as closely as possible, an external inductor is used as shown in FIG. 6. The generator's rated operating point was chosen at 12 m/s and 300 r/min, which gives 4.2 kW rated turbine power. With this rated operating point an external inductance is designed that results in the operating points of the turbine at different wind speeds as shown in FIG. 7. As is shown with this inductance, close to optimal power is obtained at lower wind speeds as well as at higher wind speeds.

From above the constraint in the wind generator design is a developed torque of Td≧134 Nm at a rated speed of 300 r/min. A second constraint is that the efficiency must be higher than 90%. Hence, the objective function, F(X), to be minimized subject to the constraint function, ε(X) is given by

$$F ( X ) = {w}_{l} {M}_{m} ( X ) + {w}_{2} {M}_{Cu} ( X ) \\ ɛ ( X ) = ( \begin{matrix}{T}_{d} ( X ) = 134 Nm \\ η ( X ) > 90 \%\end{matrix} ) \\ and \\ X = ( \begin{matrix}h \\ l\end{matrix} ) \qquad ( 9 )$$

where w₁ and w₂ are weighting factors and X is a dimensional vector containing the machine variables to be optimised. The weighting factors are directly equivalent to the cost of the copper and magnet materials at a given time. At the time of writing the weighting factor for the magnets, w₁, was considerably larger than that of the copper.

The stator diameter is taken as the maximum value possible according to the predesigned turbine blade dimensions and is equal to d=464 mm. The current density is taken as a constant in the design as J=8 A/mm². With the external inductance known and also much larger than the internal phase inductance of the generator, the phase angle, δ, of the system is approximately determined as δ=51°; this angle is also kept constant in the design optimisation.

To ensure an average air-gap flux density of 0.7 T, the flux density in the design is taken a fraction higher than 0.7 T namely as B_{g}=0.725 T. The optimal winding design and harmonic analysis show that a per unit coil side width of κ=0.37 and a per unit magnet pitch of Tₘ=0.7 can be used in the design optimisation. Finally, the values of the magnet coercivity, H_{c}, and magnet remanence, Bᵣ, in (8) depend on the chosen magnet grade discussed further below.

Another parameter to be determined is the number of poles which also affects the rotor yoke thickness. Three scenarios are analysed with a FE package to determine the optimal number of poles for this particular application, while keeping dimensions of rotor diameters, air-gap thickness and magnet thickness constant. Pole numbers of 24, 32 and 48 are examined. The number of poles is increased to a maximum value to minimise the flux per pole and, thereby, the rotor yoke thickness and rotor mass of the machine. The disadvantage associated with high pole numbers, however, is the increased risk of high leakage flux between the neighbouring permanent magnets. To ensure minimum tangential leakage flux through the air gap the requirements of (10) must be satisfied namely

hₘ≦0.51_{g} and l_{ipg}≦l (10)

This leads to a maximum number of poles that can be used which in this case is p=32; note from the design optimisation that hₘ₍ₒₚₜ₎≦0.51_{g}.

The question in relation to magnet mass and strength is if a low or a high grade material must be chosen. To investigate this, a study was conducted to determine the magnet cost and magnet mass versus magnet grade for a given air gap flux density. This led to the surprising result shown in FIG. 8; the graphs illustrate a large reduction in magnet mass with only a marginal increase in magnet cost. The consequence of this, thus, is that the strongest magnet grade must be chosen in the design optimisation, namely the N48 in this case.

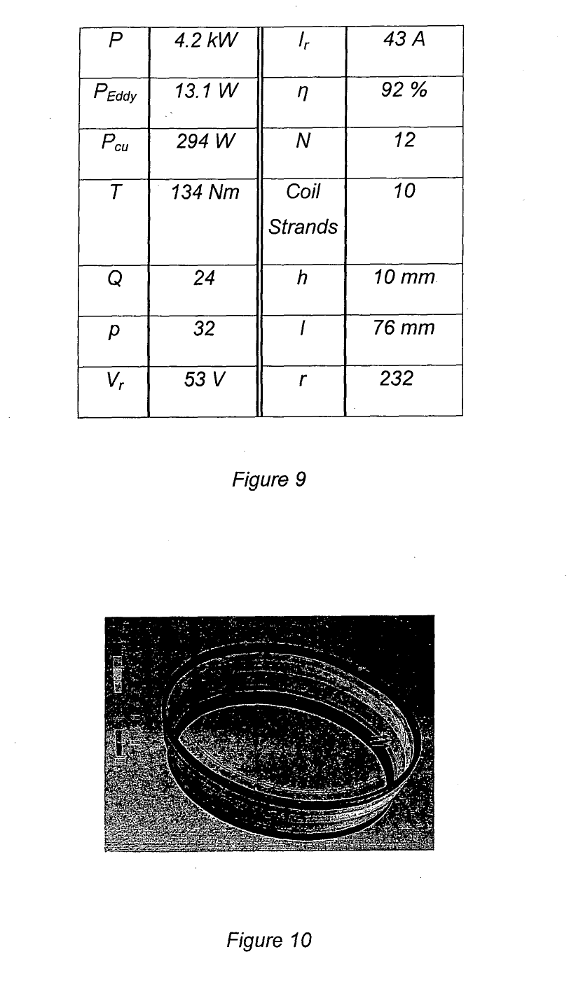

The parameters that are optimised are the stator thickness, h, and the axial active length, l, as given in (9). A Matlab® program was developed which follows an iterative process to determine the optimum values hₒₚₜ and lₒₚₜ that minimise the active mass subject to the given constraints; note in this regard that the optimum value of hₘ₍ₒₚₜ₎ is also determined from (8). It should be mentioned that the rotor yoke thickness, t, is considered in this optimisation to be large enough to ensure the required flux density of B_{g}=0.725 T as used in (8). The optimum values from the design optimisation are given in the table shown in FIG. 9; also given in the table are the rated performance data of the optimum designed generator.

The mass of the two rotor yokes has a significant impact on the overall mass of the generator. This makes the yoke thickness an important additional dimension to be optimised in minimising the mass. This second optimisation is discussed further below.

Large attraction forces on the discs of AFPM generators have been investigated in the optimal design of such a machine. It is shown that the large attraction forces cause a large increase in mass of the PM rotor discs. In a RFPM machine the magnets on the inside and outside of the two rotor yoke cylinders cause a stress distribution much similar to that of cylindrical pressure vessels and can, thus, be approximated as such. Due to the inherent strength of the cylinder topology, the yoke thickness of the PM cylinders can be decreased and the machine's mass can be kept low. To calculate the minimum cylinder wall thickness, two forces acting on the steel yokes are evident namely (i) the magnet attraction forces between the separate cylinder yokes and (ii) the centrifugal forces of the spinning rotor mass.

The two opposite rotor magnets are assumed to be of equal size in the analysis as the radius of the generator is relatively large. The force between these magnets can then be determined by

$${F}_{m} = \frac{{B}_{g }^{2}}{2 {μ}_{0}} {A}_{g} \qquad ( 11 )$$

where A_{g} is the area between the facing magnets. The centrifugal force is calculated by

$${F}_{c} = {m}_{y} {a}_{n} = {m}_{y} \frac{{( {r}_{y} ω )}^{2}}{ρ} \qquad ( 12 )$$

where m_{y} is the mass of the rotor yoke plus magnets, r_{y} is the average radius of the yoke, w is the angular velocity of the spinning yoke and p is the radius of curvature. At a rated speed of 300 r/min the inner yoke produces an outward centrifugal force of 2.28 kN. With a total of 32 magnet pairs equally spaced around the inner and outer rotor, the total inter magnet force on each rotor in the radial direction is thus 22.88 kN. This force develops an evenly distributed pressure inside the yoke which can be used in thin-walled pressure vessel calculations. A Von Mises creation now gives the minimum thickness needed to withstand these forces:

$$t = {S}_{f} ( \sqrt{\frac{3}{4}} ) ( \frac{{pr}_{y}}{{σ}_{Y}} ) = {S}_{f} ( \sqrt{\frac{3}{4}} ) ( \frac{\frac{F}{{A}_{y}} {r}_{y}}{{σ}_{Y}} ) , \qquad ( 13 )$$

where F is the total force acting on the yoke and A_{y} is the yoke area on which the pressure acts. With a safety factor of 5 and mild steel used in construction, the minimum wall thickness of the yoke is found to be 4 mm. The maximum deflection of the tips of the yoke is calculated as a mere 233 μm. The yoke wall thickness of 4 mm is confirmed with Autodesk Inventor Pro 9 finite element (FE) deformation calculator, with the result shown in FIG. 10.

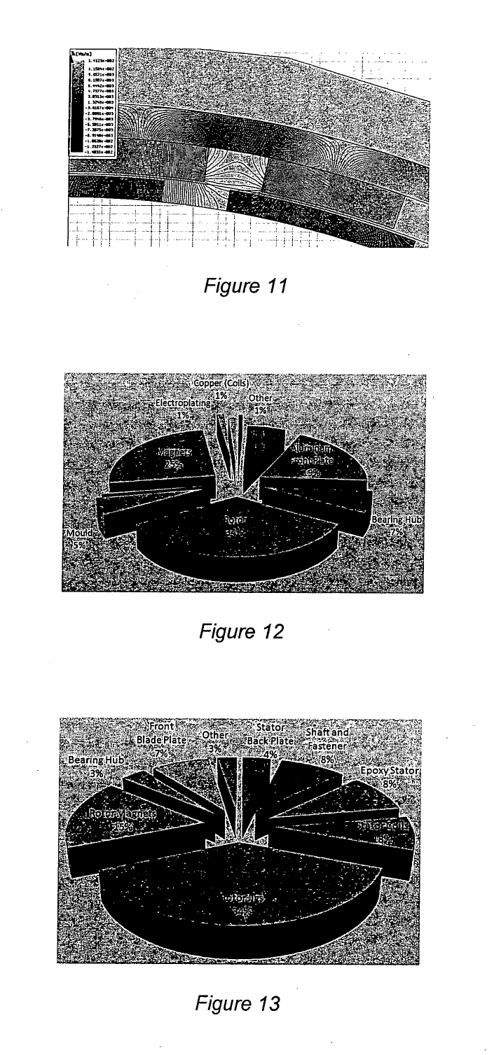

Electromagnetic FE simulations show clearly that the cylinder rotor yoke starts to saturate in terms of magnetic flux if the yoke thickness becomes too small. This magnetic flux saturation causes a decrease of flux density in the air-gap and the performance of the machine is affected greatly. An example of the magnetic saturation in the yoke is shown in the FE field plot in FIG. 11 of the RFPM generator. Magnetic flux lines in this figure are only plotted for one half of the machine. As is clear magnetic saturation occurs in the steel yoke between the opposite magnet poles. To maintain the air-gap flux density at 0.725 T, the FE electromagnetic analysis shows that the yoke thickness must not be less than 8 mm. From an electromagnetic point of view the optimum yoke thickness, thus, is 8 mm. This thickness is double the optimum 4 mm thickness from the mechanical strength analysis. The result implies that mechanical considerations do not determine the optimum yoke thickness.

The total mass of the optimum designed RFPM generator is determined by using amongst others the Autodesk Inventor Pro 9 calculator. The cost of the parts of the RFPM generator is determined from the material cost and the manufacturing of a prototype. An approximate cost representation of the generator is shown in FIG. 12.

The mass distribution of all the parts of the generator is shown in FIG. 13. In both cases of cost and mass the rotor yokes dominate—not only do the rotor yokes absorb 34% of the total cost, but they also cover a third of the total generator mass. The magnet cost is lower than expected and is a quarter of the total generator cost. The large scale production of the generators could change the cost distribution of the generator parts.

Some of the calculated and measured results of the prototype RFPM generator are given here. A test setup where the PM wind generator is connected to a 55 kW variable speed induction drive motor via a prop shaft and torque sensor was used.

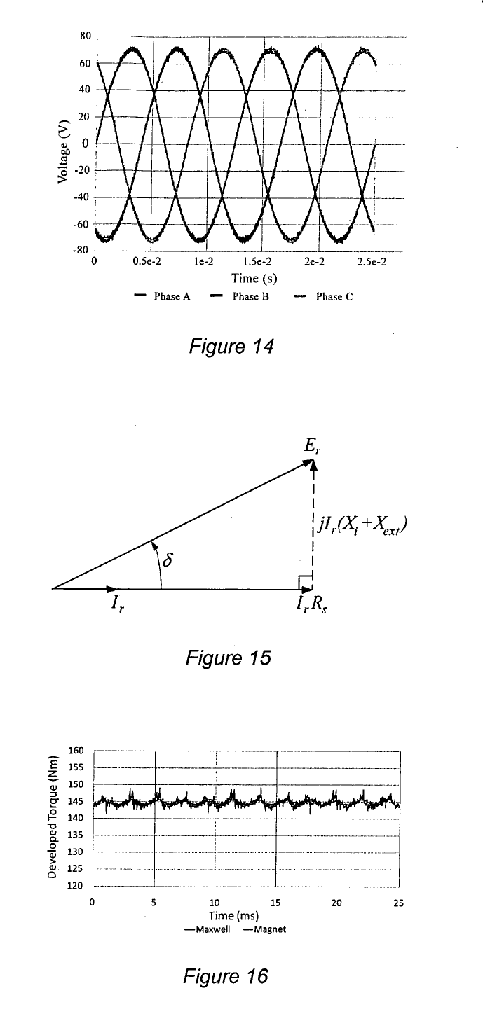

The results of open circuit test data are given in FIG. 14. The sinusoidal voltages generated at the rated speed of 300 rpm have a peak-to-peak voltage of 144 V, which gives a RMS voltage of 50.94 V. This corresponds quite accurately to the predicted value of 51 V calculated by the Matlab® design program.

Open- and short-circuit tests were performed to determine the internal synchronous reactance of the generator. From this the internal phase inductance of the generator is determined as Lᵢ=152 μH.

A load test is performed on the generator by coupling each phase of the generator through the external inductances, Lₑₓₜ, to a resistance load. The test is performed at a mechanical rotational speed of 300 r/min. Once the rated generator current, is reached the average developed torque is measured. A simplified phasor diagram is shown in FIG. 15, Eᵣ is the generator rated back-EMF, Rₛ is the total system resistance (machine and load) and Xᵢ and Xₑₓₜ are the internal and external synchronous reactances respectively. An average developed torque of 135 Nm is measured at a rated RMS line current of 42 A.

FIG. 16 depicts the FE calculated instantaneous developed torque of the generator when used in a three phase balanced resistive loading system. The average calculated developed torque, at rated speed, is 143 Nm, which is slightly higher than the analytical result which predicts 134 Nm. This value is higher than the minimum constraint mentioned in section III. The torque ripple of about 1.8 Nm (1.3%) is low as expected in air-cored electrical machines.

From the results of the analytical and finite element analysis on the design of the double rotor air-cored RFPM machine for wind generator applications it was found that it is advantageous to use a stronger magnet grade for the permanent magnets in the design; this causes a substantial decrease in the machine mass with only a marginal increase in cost. The electromagnetic design and not the mechanical design determine the yoke heights and thus the mass and cost of the rotors; the mechanical strength analysis shows that the cylindrical rotors are extremely strong to withstand the magnetic attraction forces. The cost of the permanent magnets is found to be less than 25% of the total cost of the prototype generator, which is less than expected; the cost and mass of the cylindrical rotors surprisingly dominate, but in mass production these will diminish. The total mass of the constructed 7 kW (with δ=0°) wind generator is 61 kg, which is about 34% less mass than the previously developed AFPM direct-drive of the same rating. This resembles a significant improvement over the prior art.

1.-18. (canceled)

19. An air-core stator for a permanent magnet electric generator comprising a base having attachment formations spaced apart about its surface and a plurality of stator modules each having complementary attachment formations, wherein the stator modules include at least one non-overlapping conductive winding each and are releasably secured to the base by means of the attachment formations in a side-by-side configuration so as to form a substantially annular stator body.

20. A stator as claimed in claim 19 in which the base is disc shaped and defines apertures about its periphery, the apertures serving as the attachment formations.

21. A stator as claimed in claim 19 in which each stator module is integrally moulded from a polymer resin and has a part circular outer surface, an arcuate body and a flange projecting substantially normally from an edge thereof in a direction of concave curvature of the body, the complimentary attachment formations being apertures defined in the flange and spaced apart so as to register with the attachment formations on the base, enabling the module to be bolted to the base.

22. A stator as claimed in claim 21 in which each stator module includes a plurality of generally oblong conductive coils arranged in side by side configuration on the arcuate body with their longitudinal axes substantially parallel to each other and extending across a width of the annular stator body.

23. A stator as claimed in claim 22 in which the coils are non-overlapping and compact wound.

24. A stator as claimed in claim 22 in which the coils are imbedded in the polymer resin during moulding of the stator modules.

25. A wind turbine for generating electrical power including a turbine rotor mounted for rotation to be driven by wind and a generator coupled to the turbine rotor such that the turbine rotor drives the generator, the generator comprising an air core stator located in a magnetic air gap between two generally annular rotor portions mounted to rotate together on opposite sides of the air core stator, the rotor portions including arrays of alternating polarity permanent magnets such that the permanent magnets drive magnetic flux back and forth between the rotor portions and through the air core stator in a substantially radial direction when the turbine rotor rotates, the wind turbine being characterised in that the air core stator is made up of a plurality of interchangeable stator modules, each supporting one or more compact wound conductive coils in the magnetic air gap.

26. A wind turbine as claimed in claim 25 in which the air core stator comprises a base which is securable to a stationary support structure of the wind turbine and to which the plurality of stator modules are secured in side by side configuration, each stator module having a generally arcuate body so that the bodies of the stator modules form a substantially continuous annular stator body projecting substantially normally from the base and into the magnetic air gap when secured to the base.

27. A wind turbine as claimed in claim 25 in which each stator module is integrally moulded from a polymer resin and in which the one or more compact wound conductive coils are embedded within the resin and configured to be electrically connected outside the stator module bodies.

28. A wind turbine as claimed in claim 25 in which each coil has multiple phase windings consisting of multiple individually insulated conductive wires that are wound in a concentrated manner so as to have two separate portions, namely an active length portion and an end turn portion, the end turn portion, in use, being located outside the magnetic air gap so as to traverse predominantly circumferentially and the active portion being located within the magnetic air-gap so as to traverse predominantly non-circumferentially and perpendicularly to the direction of the magnetic air-gap.

29. A stator module for a modular stator of a permanent magnet generator comprising an integrally moulded, polymeric resin body having a generally arcuate shape and a flange projecting substantially perpendicularly from an edge thereof in a direction of concave curvature of the body, at least one aperture defined in the flange, and at least one conductive winding.

30. A stator module as claimed in claim 29 in which the conductive winding is a compact wound coil having multiple conductive windings wound into a generally oblong shape, the coil being embedded in the module body.

31. A stator module as claimed in claim 30 which includes multiple coils embedded in the body such that they are arranged side by side with their major axes parallel to each other and across a width of the module body.

32. A method of manufacturing a double-sided rotor, radial flux, air-cored, permanent magnet electric generator comprising the steps of
attaching arrays of multiple alternating polarity permanent magnets to ferromagnetic back iron yokes and securing the arrays to the inside surfaces of two radially spaced apart rotor portions of the generator such that the permanent magnets drive magnetic flux back and forth through an air gap between the rotor portions;
securing a stator base having a plurality of attachment formations to a stationary support structure of the generator;
inserting a plurality of individually moulded, non-magnetic stator modules, each having an arcuate module body, complementary attachment formations and at least one conductive winding embedded in the module body, transversely into the air gap; and
securing each stator module to the stator base by means of the attachment formations on the base and the complementary attachment formations of the modules), such that the module bodies of the stator modules form an annular stator body positioned in the air gap when all the stator modules are connected to the stator base in a side by side configuration.

33. A method as claimed in claim 32 which includes the steps of embedding at least one compact wound coil into each module body and embedding multiple coils into each stator module body such that they are arranged side by with major axes parallel to each other and across a width of the annular stator body.
